(19) United States
(12) Patent Application Publication
(10) Pub. No.: US 2010/0316755 A1
(43) Pub. Date: Dec. 16, 2010

(54) MOLD ASSEMBLY FOR MAKING LIGHT GUIDE PLATE

(75) Inventor: HSIANG-HUNG CHEN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/616,868

(22) Filed: Nov. 12, 2009

(30) Foreign Application Priority Data
Jun. 10, 2009 (CN) 200910303120.8

(51) Int. Cl. B29C 45/13

(52) U.S. Cl. 425/120

(57) ABSTRACT

The light guide plate molding die includes a male mold, a mold core, and a female mold. The male mold includes a first injection hole and a second injection hole defined therein. The mold core includes an upper mold core and a lower mold core. The upper mold core is configured for insertion into the male mold and spaced apart from the first injection hole and the second injection hole. The female mold includes a first channel spatially corresponding to the first injection hole, a second channel spatially corresponding to the second injection hole, a first runner communicating with the first channel, and a second runner communicating with the second channel defined therein. The lower mold core is configured for insertion into the female mold facing the upper mold core. The male and female molds are configured for cooperatively defining a mold cavity communicating with the first and second runners.

### BACKGROUND

1. Technical Field

The present disclosure relates to molding technology and, particularly, to a mold assembly for making a light guide plate.

2. Description of Related Art

Generally, a light guide plate is manufactured by an injection molding process using a mold assembly. A sprue and a mold cavity are defined in the mold assembly. The sprue communicates with the mold cavity through a runner. In the injection molding process, molten molding material is injected into the mold cavity through the sprue and the runner. As a result, the pressure of the mold cavity away from the runner is less than that of the runner. This may cause the light guide plate to be warped during manufacturing, which decreases the quality of the obtained light guide plate.

Therefore, what is needed, is to provide a mold assembly for making a light guide plate, which can overcome the above-mentioned problem.

### BRIEF DESCRIPTION OF THE DRAWINGS

FIG. 1 is an exploded view of a mold assembly for making a light guide plate, according to an exemplary embodiment.

FIG. 2 is a cross-sectional view of the mold assembly of FIG. 1.

### DETAILED DESCRIPTION

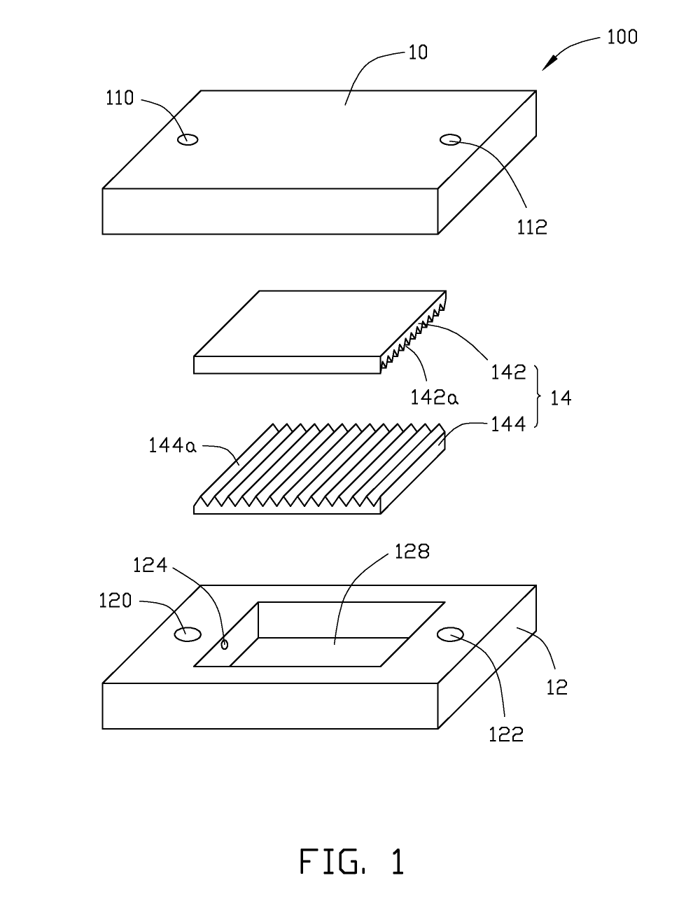

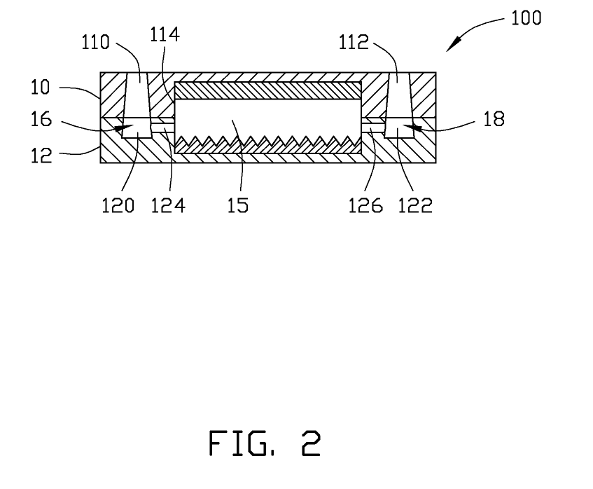

Referring to FIGS. 1-2, a mold assembly 100 for making a light guide plate, according to an exemplary embodiment, includes a male mold 10, a female mold 12 facing the male mold 10, and a mold core 14.

The male mold 10 includes a first injection hole 110, a second injection hole 112, and a first receiving recess 114 facing the female mold 12 defined therein. The first receiving recess 114 is between the first injection hole 110 and the second injection hole 112.

The female mold 12 includes a first channel 120, a second channel 122, a first runner 124, a second runner 126, and a second receiving recess 128 facing the male mold 10 defined therein. The first channel 120 spatially corresponds to the first injection hole 110. The second channel 122 spatially corresponds to the second injection hole 112. The first runner 124 is opposite to the second runner 126 and is in communication with the first channel 120. The second runner 126 is in communication with the second channel 122. The second receiving recess 128 spatially corresponds to the first receiving recess 114. The second receiving recess 128 is between the first runner 124 and the second runner 126. The second receiving recess 128 is in communication with the first runner 124 and the second runner 126.

The mold core 14 includes an upper mold core 142 and a lower mold core 144. The upper mold core 142 is configured for insertion into the first receiving recess 114. A plurality of microstructures 142a are formed on a lower surface of the upper mold core 142 facing the female mold 12. The lower mold core 144 is configured for insertion into the second receiving recess 128. A plurality of microstructures 144a are formed on an upper surface of the lower mold core 144 and faces the male mold 10.

When in use, the male mold 10 is assembled to the female mold 12. A mold cavity 15 is defined by cooperation of the male mold 10, the female mold 12 and the mold core 14. The mold cavity 15 is in communication with the first runner 124 and the second runner 126. In this embodiment, the mold cavity 15 is plate-shaped, and accordingly a light guide plate made by the mold assembly 100 is plate-shaped. The first injection hole 110 is in communication with the first channel 120 to cooperatively form a first sprue 16. The second injection hole 112 is in communication with the second channel 122 to cooperatively form a second sprue 18.

Molten molding material is then injected into the mold cavity 15 through the first sprue 16. Once the molten molding material passes through the first runner 124 to arrive at a portion of the mold cavity 15 adjacent to the second runner 126, other molten molding material is injected into the mold cavity 15 through the second sprue 18 until the molten molding material fills up the mold cavity 15. This makes the pressure of the mold cavity 15 balanced, thereby ensuring the quality of the light guide plate made by the mold assembly 100.

It can be understood that in other alternative embodiments, the mold cavity 15 may be wedge-shaped, and accordingly a light guide plate made by the mold assembly 100 is wedge-shaped.

It is to be understood, however, that even though numerous characteristics and advantages of the present embodiments have been positioned fourth in the foregoing description, together with details of the structures and functions of the embodiments, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A mold assembly comprising:
a male mold comprising a first injection hole and a second injection hole defined therein;
a mold core comprising an upper mold core and a lower mold core, the upper mold core configured for insertion into the male mold and spaced apart from the first injection hole and the second injection hole;
a female mold comprising a first channel, a second channel, a first runner, and a second runner defined therein, the first channel spatially corresponding to the first injection hole, the second channel spatially corresponding to the second injection hole, the first runner communicating with the first channel, the second runner communicating with the second channel, the lower mold core configured for insertion into the female mold and facing the upper mold core;
wherein the male mold and the female mold are configured for cooperatively defining a mold cavity, and the mold cavity is communication with the first runner and the second runner.

2. The mold assembly as claimed in claim 1, wherein the mold cavity is wedge-shaped.

3. The mold assembly as claimed in claim 1, wherein the mold cavity is plate-shaped.

4. The mold assembly as claimed in claim 1, wherein the male mold comprises a first receiving recess facing the female mold; the upper mold core is configured for insertion into the first receiving recess; and a plurality of microstructures are formed on a lower surface of the upper mold core facing the lower mold core.

5. The mold assembly as claimed in claim 1, wherein the female mold comprises a second receiving recess spatially corresponding to the first receiving recess and facing the male mold; the lower mold core is configured for insertion into the second receiving recess; a plurality of microstructures are formed on an upper surface of the lower mold core facing the upper mold core.
